(19) United States
(12) Patent Application Publication
(10) Pub. No.: US 2005/0003984 A1
(43) Pub. Date: Jan. 6, 2005

(54) Liquid detergents and cleaning products with consistency-imparting polymers

(75) Inventors: Johannes Himmrich, Eppstein (DE); Christoph Kayser, Mainz (DE); Roman Morschhaeuser, Mainz (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 10/846,408

(22) Filed: May 14, 2004

(30) Foreign Application Priority Data
May 16, 2003 (DE) 10322269.3

(51) Int. Cl. C11D 7/18

(52) U.S. Cl. 510/312

(57) ABSTRACT

Liquid washing, cleaning, disinfecting and bleaching compositions and methods for thickening such compositions with copolymers which include structural units derived from
a1) 1 to 50% by weight of the repeating structural unit of the formula (1) 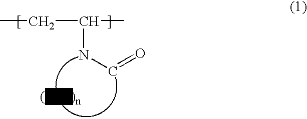 where n is an integer from 2 to 9, or
a2) 1 to 50% by weight of a mixture of the repeating structural unit of the formula (1) and the repeating structural unit of the formula (2) 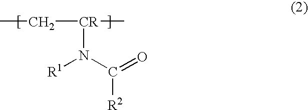
where R, R¹ and R² can be identical or different and are hydrogen or a linear or branched alkyl or alkenyl group having In each case 1 to 30 carbon atoms, and
b) 49.99 to 98.99% by weight of the repeating structural unit of the formula (3) 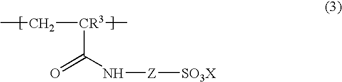
in which R³ is hydrogen, methyl or ethyl, Z is (C₁-C₈)-alkylene, n is an integer from 2 to 9 and X is Li⁺, Na⁺, K⁺, Mg⁺⁺, Ca⁺⁺, Al⁺⁺⁺, NH₄⁺, and alkylamines having alkyl substituents of (C₁-C₁₂)-alkyl or (C₂-C₁₀)-hydroxyalkyl, and c) 0.01 to 8% by weight of crosslinking structures having at least two olefinic double bonds.

The present invention relates to liquid washing, cleaning, disinfecting and bleaching compositions comprising copolymers based on acryloyldimethyltauric acid. The finished formulations are characterized by favorable rheological behavior, and by good compatibility with other components. They have high storage stability, in particular high stability of hydrolysis-sensitive components, for example oxidizing agents, in the formulations, preferably in acidic formulations, and are UV stable.

Modern liquid washing, cleaning and disinfecting compositions have to meet high requirements which are closely related to the rheology of the products: as well as having a good and rapid cleaning ability toward soiling and grease, or disinfecting ability, they must be easy to use, safe, very well tolerated by the skin, but also environmentally compatible. To improve handling for the consumer and to improve the appearance, liquid products with relatively high viscosities are increasingly coming onto the market, meaning that thickeners and gel formers play a major role.

The consistency-imparting agents used hitherto have been almost exclusively synthetic or partially synthetic polymers based on crosslinked polyacrylic acids (carbomers, carbopols), partially hydrolyzed polyacrylamides, cellulose ethers, xanthan or guar gum. In this connection, the problem of intolerance toward low pH values always arises, which limits the potential applications of many products to the neutral range or weakly acidic range.

Accordingly, it was an object of the present invention to find a thickener for washing and cleaning composition formulations which does not lose its effectiveness even in the acidic medium below pH 5.

Surprisingly, it has now been found that this serious disadvantage can be overcome through the use of hydrophobically modified copolymers based on acryloyldimethyltaurate, the preparation of which is described in EP-1 116 733.

Using these polymeric structures, it has been possible to adjust formulations for washing, cleaning and disinfecting to viscosities greater than 100 cP. In particular embodiments, the formulations have acidic character (pH<5). In addition, due to the acidic medium, it is possible to permanently stabilize pH-sensitive oxidizing agents, such as, for example, hydrogen peroxide, thereby opening up new applications in the cleaning and hygiene sector. Happily, these formulations are additionally characterized by high UV stability. This permits the use of transparent packaging materials, which are currently in great demand on the market.

The invention provides liquid washing, cleaning, disinfecting and bleaching compositions comprising copolymers which include structural units derived from
a1) 1 to 50% by weight of the repeating structural unit of the formula (1) 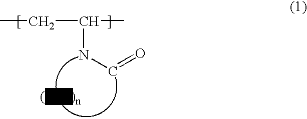
   where n is an integer from 2 to 9 or
a2) 1 to 50% by weight of a mixture of the repeating structural unit of the formula (1) and the repeating structural unit of the formula (2) 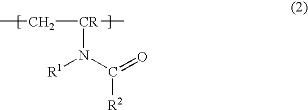
   where R, R¹ and R² can be identical or different and are hydrogen or a linear or branched alkyl or alkenyl group having in each case 1 to 30, preferably 1 to 20, in particular 1 to 12 carbon atoms and
b) 49.99 to 98.99% by weight of the repeating structural unit of the formula (3) 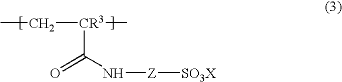
   in which R³ is hydrogen, methyl or ethyl, Z is (C₁-C₈)-alkylene, n is an integer from 2 to 9 and X is preferably Li⁺, Na⁺, K⁺, Mg⁺⁺, Ca⁺⁺, Al⁺⁺⁺, NH₄⁺, monoalkyl-ammonium-, dialkylammonium-, trialkylammonium- and/or tetraalkyl-ammonium radicals, it being possible for the alkyl substituents of the amines independently of one another to be (C₁-C₂₂)-alkyl radicals or (C₂-C₁₀)-hydroxyalkyl radicals, and
c) 0.01 to 8% by weight of crosslinking structures originating from monomers having at least two olefinic double bonds.

The mixing ratio relating to structural unit a2) can vary within any desired limits.

Preferred copolymers contain
2 to 30% by weight, with particular preference 3 to 15% by weight, of structural units a1) or a2), preferably of structural unit a2), 69.5 to 97.5% by weight, with particular preference 84.5 to 96.5% by weight, of structural unit b) and
0.01 to 5% by weight, with particular preference 0.2 to 3% by weight, with a special preference 0.5 to 2% by weight of structural unit c).

Particularly preferred structural units of formula (1) are derived from N-vinylpyrrolidone.

Suitable structural units of formula (3) include preferably alkali metal/alkaline earth metal, preferably ammonium salts of 2-acrylamido-2-methylpropan sulfonic acid, with particular preference the NH₄⁺ salt. In addition it is also possible for mono- to triethoxylated ammonium compounds with different degrees of ethoxylation to be used as counterion.

The crosslinking structural units c) are derived preferably from allyl acrylate or methacrylate, trimethylolpropane triacrylate, trimethylolpropane methacrylate, dipropylene glycol diallyl ether, polyglycol diallyl ether, triethylene glycol divinyl ether, hydroquinone diallyl ether, tetraallyloxyethane or other allyl or vinyl ethers, polyfunctional alcohols, tetraethylene glycol diacrylate, triallylamine, trimethylolpropane diallyl ether, methylenebisacrylamide and/or divinylbenzene.

Particular preference is given to allyl acrylate, allyl methacrylate, trimethylolpropane triacrylate and/or trimethylolpropane methacrylate.

With especial preference the crosslinking structures are derived from monomers of the general formula (4) 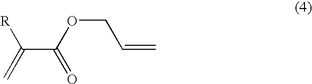
in which R is hydrogen, methyl or ethyl.

The copolymers are prepared by polymerization reaction, for example by precipitation polymerization, emulsion polymerization, bulk polymerization, solution polymerization or gel polymerization, with precipitation polymerization being particularly advantageous for the profile of properties of the copolymers used according to the invention.

As described in EP-1 116 733 the monomers corresponding to formulae (1), (2) and (3) are dissolved or dispersed in a protic solvent, preferably tert-butanol. Subsequently one or more crosslinkers c) are added to this solution or dispersion and the polymerization is initiated in a known way by addition of a radical-forming compound.

The polymerization reaction takes place preferably in a water-soluble alcohol or in a mixture of two or more alcohols having 1 to 6 carbon atoms, preferably in tert-butanol. The water content of the alcohol or alcohol mixture ought not to exceed 10% by weight, since otherwise lumps may form during the polymerization. The choice of the nature and amount of the solvent should be made such that the salt of the acrylamidoalkylsulfonic acid corresponding to formula (3), in particular of 2-acrylamido-2-methylpropanesulfonic acid, is largely soluble or dispersible therein. By largely soluble or dispersible is meant that, even after the stirrer mechanism has been shut off, no solid material settles from the solution or dispersion. The polymer which forms during the reaction, in contrast, should be largely insoluble in the chosen solvent or solvent mixture. By largely insoluble in this context is meant that in the course of the polymerization a readily stirrable, slurrylike polymer paste is formed in which no lumps or sticking develop. The filtrate obtainable by filtering the paste ought to have a solids content of not more than 5% by weight. If the copolymers are soluble to a substantial extent in the chosen solvent or solvent mixture, lumps may be formed when the polymer paste is dried.

The polymerization reaction itself is initiated in a manner known per se by means of radical-forming compounds such as azo initiators (e.g. azobisisobutyronitrile), peroxide (e.g. dilauryl peroxide) or persulfates in the temperature range from 20 to 120° C., preferably between 40 and 80° C., and is continued over a period ranging from 30 minutes to several hours.

The profile of properties of the copolymers can be varied by varying the above mixing ratio of the monomers and also of the crosslinkers. For example, the thickening effect of the polymers can be improved by the increased incorporation of acrylamidosulfonic acid/salt thereof. By incorporating more cyclic N-vinylcarboxamide, on the other hand, the electrolyte compatibility of the polymers and their solubility in nonaqueous systems is improved.

Particularly preferred acrylamidopropylsulfonic salts copolymerized are the alkali metal, alkaline earth metal, with particular preference NH₄⁺ salts. Instead of the ammonium salts it is also possible to use the free acrylamidopropylsulfonic acids and to generate the ammonium salts by introduction of ammonia before the remaining monomers are added.

The copolymers used according to the invention in washing and cleaning compositions possess a molecular weight M_{w} of from 10³ g/mol to 10⁹ g/mol, with particular preference from 10⁴ to 10⁷ g/mol, with especial preference from 5 10⁴ to 5 10⁶ g/mol. M_{w} is for the purposes of this invention generally to be determined by GPC against polystyrenesulfonic acid.

The compositions of the invention contain preferably 0.01 to 10% by weight, with particular preference 0.1 to 5% by weight, with especial preference 0.5 to 3% by weight of copolymers.

It should be noted that mixtures of two or more of the abovementioned compounds are also in accordance with the invention.

According to the invention, the above-described copolymers based on acryloyldimethyltaurate can generally be used in all washing, cleaning, disinfecting and bleaching compositions of every type. They are preferably used as thickeners in acidic cleaning composition formulations for hard surfaces made of ceramic, metal, glass or plastic, for example in liquid all-purpose cleaners, in the sanitary sector, for example liquid toilet block, lime-dissolving bath cleaner, but also dishwashing detergents. Furthermore, they are suitable for use in stain-removal salt compositions, liquid detergents and laundry bleaches.

The washing, cleaning, disinfecting and bleaching compositions according to the invention can be in the form of aqueous, aqueous/organic, in particular aqueous/alcoholic and organic formulations. Further embodiments may be: emulsions, dispersions, gels and suspensions.

In a preferred embodiment, the washing, cleaning, disinfecting and bleaching compositions according to the invention comprise an acidic component.

Suitable are organic or inorganic acids, preferably organic acids, especially preferably alpha-hydroxy acids and acids chosen from glycolic acid, lactic acid, citric acid, tartaric acid, mandelic acid, salicylic acid, ascorbic acid, pyruvic acid, oligooxamono- and dicarboxylic acids, fumaric acid, retinoic acid, aliphatic and organic sulfonic acids, benzoic acid, kojic acid, fruit acid, malic acid, gluconic acid, galacturonic acid, acidic plant and/or fruit extracts and derivatives thereof.

Furthermore, preferred embodiments may comprise bleaching disinfecting agents, examples being substances which release chlorine or bromine, or organic or inorganic peroxides.

Examples of the suitable materials which release chlorine or bromine include heterocyclic N-bromo- and N-chloroamides, examples being trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethylhydantoin, are likewise suitable.

Anhydrous, water-soluble inorganic salts are likewise suitable as bleaches, for example lithium, sodium or calcium hypochlorite and hypobromite. Chlorinated trisodium phosphate is likewise suitable.

Organic peracids and diacyl peroxides, examples being peroxy benzoic acid and its analogs substituted on the benzene ring, aliphatic and substituted aliphatic monoperoxy acids, examples being peroxylauric acid and peroxystearic acid, alkyl diperoxy acids and aryl diperoxy acids such as 1,12-diperoxydodecanoic acid, 1,9-diperoxybrassidylic acid, diperoxysebacylic acid, diperoxyisophthalic acid, and dibenzoyl peroxide.

The inorganic peroxy compounds which can be used in the context of the present invention include, for example, monopersulfates, perborates and percarbonates. The inorganic peroxy compounds are generally used in the form of alkali metal salts, preferably as the lithium, sodium and potassium salts.

The preparations according to the invention can comprise bleaching and disinfecting agents in amounts of from 0.1 to 30% by weight, particularly preferably 0.5 to 18% by weight, in particular 1.5 to 9% by weight.

The washing, cleaning, disinfecting and bleaching compositions according to the invention can comprise surfactants nonionic, anionic, cationic or amphoteric in nature, and also customary auxiliaries and additives in varying amounts.

Preferred nonionic surfactants are fatty alcohol oxethylates having about 1 to about 25 mol of ethylene oxide. The alkyl chain of the aliphatic alcohols may be linear or branched, primary or secondary, and generally contains from 8 to 22 carbon atoms. Particular preference is given to the condensation products of alcohols which contain an alkyl chain from 10 to 20 carbon atoms, with 2 to 18 mol of ethylene oxide per mole of alcohol. The alkyl chain may be saturated or else unsaturated. The alcohol ethoxylates may likewise have a narrow homolog distribution of the ethylene oxide (narrow range ethoxylates) or a broad homolog distribution of the ethylene oxide (broad range ethoxylates). Examples of commercially available nonionic surfactants of this type are Tergitol™ 15-S-9 (condensation product of a C₁₁-C₁₅ linear secondary alcohol with 9 mol of ethylene oxide), Tergitol™ 24-L-NMW (condensation product of a C₁₂-C₁₄ linear primary alcohol with 6 mol of ethylene oxide with narrow molecular weight distribution).

This class of product likewise comprises the Genapol™ grades from Clariant GmbH.

Moreover, other known grades of nonionic surfactants are also suitable according to the invention, such as polyethylene, polypropylene and polybutylene oxide adducts of alkylphenols having 6 to 12 carbon atoms in the alkyl chain, addition products of ethylene oxide with a hydrophobic base, formed from the condensation of propylene oxide with propylene glycol or addition products of ethylene oxide with a reaction product of propylene oxide and ethylenediamine.

In addition, semipolar nonionic surfactants, for example amine oxides of the formula III 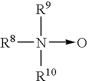
can be used, in which R⁸ is an alkyl, hydroxyalkyl or alkylphenol group or mixtures thereof with a chain length of from 8 to 22 carbon atoms;

R⁹ is an alkylene or hydroxyalkylene group having 2 to 3 carbon atoms or mixtures thereof; R¹⁰ is an alkyl or hydroxyalkyl group having 1 to 3 carbon atoms or a polyethylene oxide group having 1 to 3 ethylene oxide units. The R¹⁰/R⁹ groups can be joined together via an oxygen or nitrogen atom and thus form a ring.

These amine oxides include, in particular, C₁₀-C₁₈-alkyldimethylamine oxides and C₈-C₁₂-alkoxyethyidihydroxyethylamine oxides.

Instead of or in addition to the nonionic surfactants, the mixtures according to the invention can also comprise anionic surfactants.

Suitable anionic surfactants are especially straight-chain and branched alkyl sulfates, alkylsulfonates, alkyl carboxylates, alkyl phosphates, alkyl ester sulfonates, arylalkylsulfonates, alkyl ether sulfates and mixtures of said compounds. Some of the suitable grades of anionic surfactants will be described below in more detail.

Alkyl Ester Sulfonates

Alkyl ester sulfonates are linear esters of C₈-C₂₀ carboxylic acids (i.e. fatty acids) which are sulfonated by SO₃, as described in “The Journal of the American Oil Chemists Society”, 52 (1975), pp. 323-329. Suitable starting materials are natural fatty derivatives, such as, for example, tallow or palm oil fatty acid.

Alkyl Sulfates

Alkyl sulfates are water-soluble salts or acids of the formula ROSO₃M, in which R is preferably a C₁₀-C₂₄ hydrocarbon radical, preferably an alkyl or hydroxyalkyl radical having 10 to 20 carbon atoms, particularly preferably a C₁₂-C₁₈-alkyl or hydroxyalkyl radical. M is hydrogen or a cation, e.g. an alkali metal cation (e.g. sodium, potassium, lithium) or ammonium or substituted ammonium, e.g. a methylammonium, dimethylammonium and trimethylammonium cation or a quaternary ammonium cation, such as tetramethylammonium and dimethylpiperidinium cation and quaternary ammonium cations derived from alkylamines, such as ethylamine, diethylamine, triethylamine and mixtures thereof. Alkyl chains with C₁₂-C₁₆ are preferred here for low washing temperatures (e.g. below about 50° C.) and alkyl chains with C₁₆-C₁₈ are preferred for higher washing temperatures (e.g. above about 50° C.).

Alkyl Ether Sulfates

The alkyl ether sulfates are water-soluble salts or acids of the formula RO(A)ₘSO₃M, in which R is an unsubstituted C₁₀-C₂₄-alkyl or hydroxyalkyl radical having 10 to 24 carbon atoms, preferably a C₁₂-C₂₀-alkyl or hydroxyalkyl radical, particularly preferably a C₁₂-C₁₈-alkyl or hydroxyalkyl radical. A is an ethoxy or propoxy unit, m is a number greater than 0, typically between about 0.5 and about 6, particularly preferably between about 0.5 and about 3, and M is a hydrogen atom or a cation, such as, for example, a metal cation (e.g. sodium, potassium, lithium, calcium, magnesium, etc.), ammonium or a substituted ammonium cation. Examples of substituted ammonium cations are methylammonium, dimethylammonium, trimethylammonium and quaternary ammonium cations, such as tetramethylammonium and dimethylpiperidinium cations, and also those derived from alkylamines, such as ethylamine, diethylamine, triethylamine, mixtures thereof and the like. Examples which may be mentioned are C₁₂-C₁₈-alkyl polyethoxylate(1.0)sulfate, C₁₂-C₁₈-alkyl polyethoxylate(2.25) sulfate, C₁₂-C₁₈-alkyl polyethoxylate(3.0) sulfate, C₁₂-C₁₈-alkyl polyethoxylate(4.0) sulfate, where the cation is sodium or potassium.

Other anionic surfactants which are useful for use in washing and cleaning compositions are C₈-C₂₄ olefinsulfonates, sulfonated polycarboxylic acids prepared by sulfonation of the pyrolysis products of alkaline earth metal citrates, as described, for example, in British patent GB 1,082,179, alkylglycerol sulfates, fatty acylglycerol sulfates, oleylglyceryl sulfates, alkylphenol ether sulfates, primary paraffin sulfonates, alkyl phosphates, alkyl ether phosphates, isethionates, such as acyl isethionates, N-acyltaurides, alkyl succinamates, sulfosuccinates, monoesters of sulfosuccinates (particularly saturated and unsaturated C₁₂-C₁₈ monoesters) and diesters of sulfosuccinates (particularly saturated and unsaturated C₁₂-C₁₈ diesters), acyl sarcosinates, sulfates of alkylpolysaccharides, such as sulfates of alkyloyl glycosides, branched primary alkyl sulfates and alkyl polyethoxycarboxylates, such as those of the formula RO(CH₂CH₂)ₖCH₂COO⁻M⁺ in which R is a C₈-C22-alkyl, k is a number from 0 to 10 and M is a cation which forms a soluble salt. Resin acids or hydrogenated resin acids, such as rosin or hydrogenated rosin or tall oil resins and tall oil resin acids can likewise be used. Further examples are described in “Surface Active Agents and Detergents” (Vol. I and II, Schwartz, Perry and Berch). A large number of such surfactants is also claimed in U.S. Pat. No. 3,929,678.

Examples of amphoteric surfactants which may be used in the formulations of the present invention are primarily those which have broadly been described as derivatives of aliphatic secondary and tertiary amines in which the aliphatic radical may be linear or branched and in which one of the aliphatic substituents contains between 8 and 18 carbon atoms and contains an anionic, water-soluble group, such as, for example, carboxy, sulfonate, sulfate, phosphate or phosphonate.

Further preferred amphoteric surfactants are alkyldimethylbetaines, alkylamidobetaines and alkyldipolyethoxybetaines with an alkyl radical which may be linear or branched, having 8 to 22 carbon atoms, preferably having 8 to 18 carbon atoms and particularly preferably having 12 to 18 carbon atoms. These compounds are marketed, for example, by Clariant GmbH under the trade name Genagen® CAB.

Auxiliaries and Additives

Depending on intended application, the washing and cleaning compositions comprise, as well as said surfactants, also the auxiliaries and additives specific in each case, for example builders, salts, bleaches, bleach activators, optical brighteners, complexing agents, graying inhibitors, solubility promoters, enzymes, thickeners, preservatives, fragrances and dyes, pearlizing agents, foam inhibitors, sequesterants.

Suitable organic and inorganic builders are salts which are neutral or, in particular, alkaline and which are able to precipitate out calcium ions or to bind them in complexes. Suitable and particularly ecologically acceptable builder substances, such as finely crystalline, synthetic water-containing zeolites of the type NaA which have a calcium-binding capacity in the range from 100 to 200 mg of CaO/g are preferably used. In nonaqueous systems, phyllosilicates are preferably used. Zeolite and the phyllosilicates can be present in the composition in an amount up to 20% by weight. Organic builder substances which can be used are, for example, the percarboxylic acids preferably used in the form of their sodium salts, such as citric acid and nitriloacetate (NTA), ethylenediaminetetraacetic acid, provided such a use is not precluded for ecological reasons. Analogously to this, it is also possible to use polymeric carboxylates and salts thereof. These include, for example, the salts of homopolymeric or copolymeric polyacrylates, polymethacrylates and in particular copolymers of acrylic acid with maleic acid, preferably those comprising 50% to 10% of maleic acid and also polyvinylpyrrolidone and urethanes. The relative molecular mass of the homopolymers is generally between 1000 and 100 000, that of the copolymers is between 2000 and 200 000, preferably 50 000 to 120 000, based on the free acid, particularly suitable are also water-soluble polyacrylates which are crosslinked, for example, with about 1% of a polyallylether of sucrose and which have a relative molecular mass above one million. Examples thereof are the polymers obtainable under the name Carbopol 940 and 941. The crosslinked polyacrylates are used in amounts not exceeding 1% by weight, preferably in amounts of from 0.2 to 0.7% by weight.

As foam inhibitors, the compositions according to the invention can comprise fatty acid alkyl ester alkoxylates, organopolysiloxanes and mixtures thereof with microfine, optionally silanized silica, and paraffins, waxes, microcrystalline waxes and mixtures thereof with silanized silica. It is also advantageously possible to use mixtures of different foam inhibitors, e.g. those of silicone oil, paraffin oil or waxes. Preferably, foam inhibitors are bonded to a granular, water-soluble or -dispersible carrier substance.

The liquid washing compositions can comprise optical brighteners, for example derivatives of diaminostilbenedisulfonic acid or alkali metal salts thereof which can be readily incorporated into the dispersion. The maximum content of brighteners in the compositions according to the invention is 0.5% by weight, preference being given to using amounts of from 0.02 to 0.25% by weight.

The desired viscosity of the compositions can be adjusted by adding water and/or organic solvents or by adding a combination of organic solvents and further thickeners.

In principle, suitable organic solvents are all mono- or polyhydric alcohols. Preference is given to using alcohols having 1 to 4 carbon atoms, such as methanol, ethanol, propanol, isopropanol, straight-chain and branched butanol, glycerol and mixtures of said alcohols. Further preferred alcohols are polyethylene glycols with a relative molecular mass below 2000. Particular preference is given to using polyethylene * glycol with a relative molecular mass between 200 and 600 and in amounts up to 45% by weight, and of polyethylene glycol with a relative molecular mass between 400 and 600 in amounts of from 5 to 25% by weight. An advantageous mixture of solvents consists of monomeric alcohol, for example ethanol and polyethylene glycol in the ratio 0.5:1 to 1.2:1, where the liquid washing compositions according to the invention can comprise 8 to 12% by weight of such a mixture.

Further suitable solvents are, for example, triacetin (glycerol triacetate) and 1-methoxy-2-propanol.

The thickeners used are preferably hydrogenated castor oil, salts of long-chain fatty acids, preferably in amounts of from 0 to 5% by weight and in particular in amounts of from 0.5 to 2% by weight, for example sodium, potassium, aluminum, magnesium and titanium stearates or the sodium and/or potassium salts of behenic acid, and also polysaccharides, in particular xanthan gum, guar guar, agar agar, alginates and tyloses, carboxymethylcellulose and hydroxyethylcellulose, and also relatively high molecular weight polyethylene glycol mono- and diesters of fatty acids, polyacrylates, polyvinyl alcohol and polyvinylpyrrolidone.

Suitable enzymes are those from the class of proteases, lipases, amylases and mixtures thereof. Their proportion may be 0.2 to 1% by weight. The enzymes can be adsorbed to carrier substances and/or embedded in coating substances.

In order to bind traces of heavy metals, the salts of polyphosphoric acids, such as 1-hydroxyethane-1,1-diphosphonic acid (HEDP) and diethylenetriaminepentamethylenephosphonic acid (DTPMP), preferably in weight amounts of from 0.1 to 1.0% by weight, can be used.

Suitable preservatives are, for example, phenoxyethanol, formaldehyde solution, parabens, pentanediol or sorbic acid.

Suitable pearlizing agents are, for example, glycol distearic esters, such as ethylene glycol distearate, but also fatty acid monoglycol esters.

Suitable salts or extenders are, for example, sodium sulfate, sodium carbonate and sodium silicate (waterglass).

Typical individual examples of further additives are sodium borate, starch, sucrose, polydextrose, stilbene compounds, methylcellulose, toluenesulfonate, cumenesulfonate, soaps and silicones.

The compositions according to the invention are usually adjusted to a pH in the range 1 to 12, preferably pH 2.1 to 7.8, particularly preferably 2.2 to 6.5.

By using copolymers containing acryloyidimethyltaurate, it was possible to thicken formulations with a pH of <5 to viscosities above 100 mPas. These formulations firstly have the advantage that the viscosification prevents “splashing” of the cleaning composition and thereby ensures safer use. In addition, the increased viscosity provides for slower run-off of the cleaning composition from the surfaces and thus guarantees a longer contact time. As a result of the broad pH tolerance of the polymers used, it is possible for the first time to use relatively strong organic acids, such as, for example, citric acid, malic acid, alpha-hydroxycarboxylic acids and oxalic acid, in free form. Improved effectiveness, specifically toward limescale deposits, can thus be achieved.

In said formulations, hydrophobically modified copolymers containing acryloyldimethyltaurate are used in an amount of from 0.01 to 10% by weight. Preference is given to working with an amount of from 0.1 to 5% by weight. Particular preference is given to the range from 0.2 to 2% by weight. Depending on the amount of polymer used, the viscosity of the resulting gels can be between 100 and 100 000 mPas.

Liquid Cleaning Gels Comprising Water/Organic Solvent Mixtures

The thickening of organic solvents, specifically alcohols, in combination with anionic and nonionic surfactants and other formulation constituents is readily possible through the use of copolymers containing acryloyldimethyltaurate. To qualify this, it should be noted that only water-compatible organic solvents are within the meaning of the invention. Nonlimiting examples which may be mentioned are ethanol, propanol, isopropanol, DMSO, NMP, acetone, methanol and butanol. The resulting gels can comprise between 0.1 and 90% by weight of organic solvent fraction. Preference is given to a fraction of from 5 to 80% by weight. Particular preference is given to gels with a content of organic solvents of from 20 to 60% by weight. In general, copolymers containing acryloyldimethyltaurate are used in these formulations in an amount of from 0.01 to 10% by weight. Preference is given to working with an amount of from 0.1 to 5% by weight. Particular preference is given to the range from 0.2 to 2% by weight. Here, the viscosities of the resulting cleaning gels comprising organic solvents can vary between 100 and 100 000 mPas, depending on the amount of polymer used.

A field of use which may be mentioned here is also the cleaning of grease-encrusted hard surfaces, such as tiles, glass or ceramic or metal. Possible fields of use according to the invention are, for example, bath cleaners, glass cleaners, and floor cleaners.

Liquid Cleaning Gels Comprising Disinfectants

Disinfectant gels play a large role in the hygiene sector and have been enjoying increasing popularity in the marketplace for a number of years. Specifically, gels used as “liquid toilet blocks” have been gaining ground for years in the sanitary sector.

The thickening of aqueous disinfectant solutions by conventional thickeners based on cellulose ethers or polyacrylic acids sometimes requires a high use concentration of these polymers and is additionally limited to the neutral to weakly acidic pH range.

The use of copolymers containing acryloyldimethyltaurate can overcome this limitation. It is possible for the first time to combine liquid cleaning gels containing disinfectants with acidic formulation constituents such as fruit acid or alpha-hydroxycarboxylic acids and thus to also achieve a “limescale-dissolving” effect as well as the antiseptic effect.

Copolymers containing acryloyldimethyltaurate are used in said formulations in an amount of from 0.01 to 10% by weight. Preference is given to working with an amount of from 0.1 to 5% by weight. Particular preference is given to the range from 0.2 to 2% by weight. Depending on the amount of polymer used, the viscosity of the resulting gels can be between 100 and 100 000 mPas.

Thickening of Acidic Solutions Containing Peroxide with Acryloyidimethyltaurate Polymers

For liquid formulations of peroxide solutions, it is desirable to thicken these. This makes handling simpler and safer. Formulations according to the invention can comprise organic or inorganic peroxides, in particular hydrogen peroxide or a mixture of these. For various applications, it is desirable for the peroxide solutions to adhere to the substrate and not run off so that the effect can develop completely. However, solutions of peroxide with conventional thickeners can only be thickened or stabilized with difficulty over a prolonged period. The reason for this is that a hydrogen peroxide solution is comparatively unstable even at neutral or only weakly acidic pH values. During the decomposition, the thickeners are also attacked and the viscosity is greatly reduced over time. This additionally results in a considerable loss in hydrogen peroxide activity. At an acidic pH, the decomposition of hydrogen peroxide is greatly retarded, but the thickening ability of thickeners based on acrylic acid breaks down at pH values of <5.5.

The use of acryloyldimethyltaurate polymers according to the invention in bleach solutions thickens the formulation also at pH values significantly below the threshold value of pH 5. The thickening ability of the polymers according to the invention remains virtually constant in a pH value range from 1 to 9. Even formulations with pH values around pH 1 are therefore accessible with the thickeners according to the invention. In this pH range, no noticeable decomposition of H₂O₂ takes place over normal storage periods, meaning that the acryloyldimethyltaurate polymers according to the invention are not attacked and destroyed and thus the viscosity of the formulation according to the invention remains virtually constant.

To illustrate the invention, a number of nonlimiting potential uses of such acidic thickened hydrogen peroxide solutions is listed below:
Bleaching solutions e.g. for the cleaning of laundry (liquid stain-removal salt) or dishes:
A solution of 0.1 to 30% ww H₂O₂, preferably from 1 to 15% ww, particularly preferably from 3 to 10% ww, can be thickened by means of acryloyldimethyltaurate polymers according to the invention at pH values of <5. Even at elevated storage temperatures, a viscosity stable for months is found. The thickening of the bleaching solution makes it easier for the user to establish the optimum dosing. The solution does not splash and handling is therefore safer.

Peroxide-containing cleaners can be used, for example, in the field of hard-surface cleaning in the hygiene or sanitary sector. In this case, formulations can be prepared which also comprise anionic and nonionic surfactants. Those compositions for, for example, the cleaning of toilets, are very useful. The peroxide-containing cleaner adheres to the ceramic and can thus develop its optimum cleaning and disinfecting action.

Gel or liquid filled long-term cleaners (liquid toilet blocks) for hanging in the cistern or the WC bowl can be realized with a similar formulation. Some of the gel-like thickened solution is distributed during each flushing operation with the stream of water in the bowl and thus provides a cleaning and disinfecting action. Using the acryloyldimethyltaurate polymers according to the invention, clear formulations are accessible which correspond to the current trend for clear formulations and transparent packagings.

1. A liquid washing, cleaning, disinfecting or bleaching composition comprising copolymers including structural units derived from
a1) 1 to 50% by weight of the repeating structural unit of the formula (1) 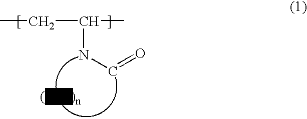
where n is an integer from 2 to 9 or
a2) 1 to 50% by weight of a mixture of the repeating structural unit of the formula (1) and the repeating structural unit of the formula (2) 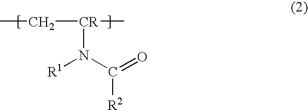
where R, R¹ and R² are identical or different and are hydrogen or a linear or branched alkyl or alkenyl group having in 1 to 30 carbon atoms and
b) 49.99 to 98.99% by weight of the repeating structural unit of the formula (3) 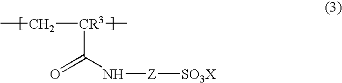
in which R³ is hydrogen, methyl or ethyl, Z is (C₁-C₈)-alkylene, n is an integer from 2 to 9 and X is Li⁺, Na⁺, K⁺, Mg⁺⁺, Ca⁺⁺, Al⁺⁺⁺, NH₄⁺, monoalkylammonium, dialkylammonium, trialkylammonium or tetraalkylammonium radical, it being possible for the alkyl substituents of the amines independently of one another to be (C₁-C₂₂)-alkyl radicals or (C₂-C₁₀)-hydroxyalkyl radicals, and
c) 0.01 to 8% by weight of at least one crosslinking structure originating from monomers having at least two olefinic double bonds.

2. The liquid washing, cleaning, disinfecting or bleaching composition as claimed in claim 1, wherein the copolymers have a molecular weight M_{w} of from 10³ g/mol to 10⁹ g/mol.

3. The liquid washing, cleaning, disinfecting or bleaching composition as claimed in claim 1 structural unit a is a Li⁺, Na⁺, K⁺, Mg⁺⁺, Ca⁺⁺, Al⁺⁺⁺, NH₄⁺, monoalkylammonium, dialkylammonium, tralkylammonium or tetraalkylammonium salts, where the alkyl substituents of the amines are, independently of one another, (C₁-C₂₂)-alkyl radicals.

4. The liquid washing, cleaning, disinfecting or bleaching composition as claimed in claim 1, wherein, based on the total mass of the copolymers, the content of acryloyidimethyltauric acid or acryloyidimethyltaurates is 0.1 to 99.9% by weight

5. The liquid washing, cleaning, disinfecting or_bleaching composition as claimed in claim 1, wherein the at least one crosslinking structure originating from monomers having at least two olefinic double bonds is an olefinically unsaturated monomer selected from the group consisting of N-vinylformamide (VIFA), N-vinylmethylformamide, N-vinylmethylacetamide (VIMA) and N-vinylacetarnide; cyclic N-vinylamides (N-vinyllactams) with a ring size from 3 to 9; amides of acrylic acid and methacrylic acid; alkoxylated acrylamides and methacrylamides; N,N-dimethylarminomethacrylate; diethylaminomethyl methacrylate; acryl- and methacrylamidoglycolic acid; 2- and 4-vinylpyridine; vinyl acetate; glycidyl methacrylate; styrene; acrylonitrile; stearyl acrylate; and lauryl methacrylate.

6. The liquid washing, cleaning, disinfecting or bleaching composition as claimed in claim 1, wherein R, R¹ and R² are identical or different and are a linear or branched alkyl or alkenyl group having 1 to 20 carbon atoms.

7. The liquid washing, cleaning, disinfecting or bleaching composition as claimed in claim 1, wherein R, R¹ and R² are identical or different and are a linear or branched alkyl or alkenyl group having 1 to 12 carbon atoms.

8. The liquid washing, cleaning, disinfecting or bleaching composition as claimed in claim 1, wherein X is a monoalkylammonium, dialkylammonium, trialkylammonium or tetmalkylammonium radical, wherein the alkyl substituents of the amines independently of one another are (C₁-C₂₂)-alkyl radicals or (C₂-C₁₀)-hydroxyalkyl radicals.

9. The liquid cleaning disinfecting or bleaching composition as claimed in claim 3, wherein the (C₁-C₂₂)-alkyl radicals are substituted by up to 3 (C₂-C₁₀)-hydroxyalkyl groups.

10. The liquid cleaning disinfecting or bleaching composition as claimed in claim 5, wherein the cyclic N-vinylamides (N-vinyllactams) with a ring size from 3 to 9 are N-vinylpyrrolidone (NVP) or N-vinylcaprolactam.

11. The liquid cleaning disinfecting or bleaching composition as claimed in claim 5, wherein the amides of acrylic acid and methacrylic acid are acrylamide, methacrylamide, N,N-dimethylacrylamide, N,N-diethylacrylamide or N,N-dilsopropylacrylamide.

12. The liquid cleaning disinfecting or bleaching composition as claimed in claim 5, wherein the alkoxylated acrylamides and methacrylamides are hydroxyethyl methacrylate, hydroxymethylmethacrylamide, hydroxyethylmethacrylamide, hydroxypropylmethacrylamide and succinic mono-[2-(methacryloyloxy)ethyl ester].

13. A method for thickening a liquid cleaning composition having an acidic character, said method comprising adding to the liquid cleaning composition copolymers including structural units derived from
a1) 1 to 50% by weight of the repeating structural unit of the formula (1) 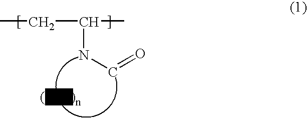
where n is an integer from 2 to 9 or
a2) 1 to 50% by weight of a mixture of the repeating structural unit of the formula (1) and the repeating structural unit of the formula (2) 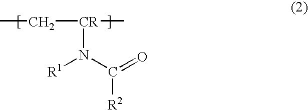
where R, R¹ and R² are identical or different and are hydrogen or a linear or branched alkyl or alkenyl group having in 1 to 30 carbon atoms and
b) 49.99 to 98.99% by weight of the repeating structural unit of the formula (3) 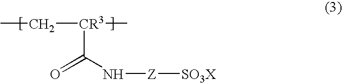
in which R³ is hydrogen, methyl or ethyl, Z is (C₁-C₈)-alkylene, n is an integer from 2 to 9 and X is Li⁺, Na⁺, K⁺, Mg⁺⁺, Ca⁺⁺, Al⁺⁺, NH₄⁺, monoalkylammonium, dialkylammonium, trialkylammonium or tetraalkylammonium radical, it being possible for the alkyl substituents of the amines independently of one another to be (C₁-C₁₂)-alkyl radicals or (C₂-C₁₀)-hydroxyalkyl radicals, and
c) 0.01 to 8% by weight of at least one crosslinking structure originating from monomers having at least two olefinic double bonds.

14. The method of claim 13, wherein the acidic character is a pH less than 5.

15. The method of claim 13, wherein the liquid cleaning composition has a viscosity greater than 100 cP following said addition.
